(19) United States
(12) Patent Application Publication
(10) Pub. No.: US 2026/0287730 A1
(43) Pub. Date: Sep. 24, 2026

(54) DETERMINATION OF BEST DISPLAYED ELLIPSE FOR GEO-LOCATING OF WIRELESS DEVICES WHEN USING ROUND TRIP TIME AND ANGLE OF ARRIVAL

(71) Applicant: SR Technologies, Inc., Sunrise, FL (US)

(72) Inventors: Mark Passler, Rockville, MD (US); Reese Boucher, Rockville, MD (US)

(21) Appl. No.: 19/468,826

(22) Filed: Feb. 3, 2026

Related U.S. Application Data
(60) Provisional application No. 63/756,672, filed on Feb. 10, 2025.

(51) Int. Cl. G01S 13/76

(52) U.S. Cl. CPC G01S 13/765

(57) ABSTRACT

A method for geo-locating a target station including transmitting, from a measuring station, ranging packets to a target station and receiving, at the measuring station, response packets in response to the ranging packets. Round trip times (RTTs) are determined based on the ranging packets and the response packets and angles of arrival (AOAs) are determined based on the response packets. A plurality of RTT circular error probability (CEP) ellipses are generated based on the RTTs and a plurality of AOA CEP ellipses are generated based on the AOAs. An RTT stability factor is calculated for a first RTT CEP ellipse and an AOA stability factor is calculated for a first AOA CEP ellipse. The RTT and AOA stability factors are compared to a threshold and, based on at least one result of the comparisons, either the first RTT CEP ellipse, the first AOA CEP ellipse, both CEP ellipses, or neither CEP ellipse is selected for display to locate the target station

### CROSS-REFERENCE TO RELATED APPLICATIONS

This application claims priority to U.S. Provisional Application No. 63/756,672, filed on Feb. 10, 2025 and titled “DETERMINATION OF BEST DISPLAYED ELLIPSE FOR GEO-LOCATING OF WIRELESS DEVICES WHEN USING ROUND TRIP TIME AND ANGLE OF ARRIVAL,” the entire disclosure of which is hereby incorporated by reference.

### TECHNICAL FIELD

The present disclosure relates to geo-location of wireless devices, and in particular to methods, devices, and systems for the geo-location of wireless devices.

### BACKGROUND

The location of wireless devices may be determined using round trip time (RTT) and angle of arrival (AOA) measurements. In an active location scheme, a wireless measuring station transmits request packets to a target station and measures the time of arrival of response packets to calculate RTT, which is directly proportional to the distance between the stations. The AOA method determines the direction from which the response signal is received. For both RTT and AOA measurements, the target location may be derived by minimizing the sum of squared residuals (SSR). Once the minimum SSR is found, a confidence ellipse, known as the circular error probability (CEP) ellipse, may be calculated to define the ellipse's length, width, and orientation. However, systematic errors can cause the calculated CEP ellipses to change in position and size from measurement to measurement, creating challenges in determining whether to merge the CEP ellipses or display one ellipse over the other based on relative residual errors and the degree of agreement between the ellipses.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

In various examples, the subject matter described herein relates to systems and methods for the geo-location of wireless devices. According to some embodiments, a method for geo-locating a target station includes transmitting, from a measuring station, a plurality of ranging packets to a target station and receiving, at the measuring station, a plurality of response packets transmitted by the target station in response to the plurality of ranging packets. A plurality of round trip times (RTTs) are determined based on the plurality of ranging packets and the plurality of response packets and a plurality of angles of arrival (AOAs) are determined based on the plurality of response packets. A plurality of RTT circular error probability (CEP) ellipses are generated based on the plurality of RTTs and a plurality of AOA CEP ellipses are generated based on the plurality of AOAs. An RTT stability factor is calculated for a first selected RTT CEP ellipse. The RTT stability factor indicates a level of agreement between the first RTT CEP ellipse and a preset number of immediately previous RTT CEP ellipses of the plurality of RTT CEP ellipses. An AOA stability factor is calculated for a first AOA CEP ellipse. The AOA stability factor indicates a level of agreement between the first AOA CEP ellipse and a preset number of immediately previous AOA CEP ellipses of the plurality of AOA CEP ellipses. The RTT and AOA stability factors are compared to a threshold, and, based on at least one result of the comparisons, either the first RTT ellipse, the AOA CEP ellipse, both CEP ellipses, or neither CEP ellipse is selected for display to locate the target station.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a diagram of an example of a wireless measuring station, in accordance with some embodiments.

FIG. 2 is a diagram of an example circular error probability (CEP) ellipse, in accordance with some embodiments.

FIG. 3 is a diagram of an example set of consecutive CEP ellipses, in accordance with some embodiments.

FIG. 4 is a diagram of an example set of consecutive CEP ellipses, in accordance with some embodiments.

FIG. 5 is a diagram of an example of a larger CEP ellipse and a smaller CEP ellipse, in accordance with some embodiments.

FIG. 6 illustrates a block diagram of an exemplary wireless communication device, in accordance with some embodiments.

FIG. 7 is a flowchart of a process for evaluating CEP ellipses, in accordance with some embodiments.

FIG. 8 is a flowchart of a process for evaluating CEP ellipses, in accordance with some embodiments.

FIG. 9 is a flowchart of a process for evaluating CEP ellipses, in accordance with some embodiments.

FIG. 10 is a flowchart of a process for selecting a CEP ellipse, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

The location of wireless devices may be determined by various methods. These methods may be classified as active, passive, and combined active and passive. In an active location scheme, a device (e.g., a wireless measuring station) transmits certain packets to a device being located (e.g., a target station). A common method may be used to measure the time of arrival (TOA) of a response packet from the target device and to compare the TOA to the time of departure (TOD) of the request packet that was transmitted by the wireless measuring station to determine a round trip time (RTT). If the turnaround time for the target station to receive the request packet from the wireless measuring station and to start to transmit the response packet is known, or is known to be a constant, then the time difference at the wireless measuring station between the TOA and the TOD (i.e., the RTT) minus the turnaround time at the target station will be directly proportional to twice the distance of the target station from the wireless measuring station.

For example, when the target station is a wireless device based upon IEEE 802.11 technology, and the request packet transmitted from the wireless measuring station to the target station is a data packet, the response packet from the target station will most likely be an acknowledgement (ACK) packet. If the request packet transmitted from the wireless measuring station to the target station is a control packet, for example, a request-to-send (RTS) packet, the response packet from the target station will most likely be a clear-to-send (CTS) packet. In these two examples, the turnaround time at the target station is defined in the IEEE 802.11 standard as the short interframe spacing (SIFS), which is a preset value. Hence, the propagation time, td, between the wireless measuring station and the target station is provided by equation (1):

$$td = ( RTT - SIFS ) / 2 \qquad ( 1 )$$

More specifically, the distance d between the wireless measuring station and the target station is provided by equation (2):

$$d = td * c . \qquad ( 2 )$$

In equation (2), c is the speed of light.

In other examples, the target station is a wireless device based upon Bluetooth technology, for example, as specified in “Bluetooth Core Specification” Revision v5.2, Revision Date: 2019 Dec. 31 (“Bluetooth® Specification”). In such examples, if the request packet transmitted from the wireless measuring station (e.g., acting as a master device) to the target station (e.g., acting as a slave device) is a Poll packet, the response packet from the target station will generally be a Null packet. The target station timer will be delayed by the propagation time, d/c, relative to the wireless measuring station. Thus, response packets (e.g., Nulls) from the target station arrive at the wireless measuring station delayed by the propagation time d/c. Accordingly, Null packets from the target station arrive delayed by a time of d/c from the travel time after accounting for a nominal 625 microseconds (μs) difference, tsd, in the master time slot compared to the slave time slot, as provided by equation (3):

$$t d = ( RTT - t s d ) / 2. \qquad ( 3 )$$

The distance d between the wireless measuring station and the target station is provided by equation (2).

Another location method is to determine the direction from which the response packet (or signal) from the target device is received, i.e., the angle of arrival (AOA).

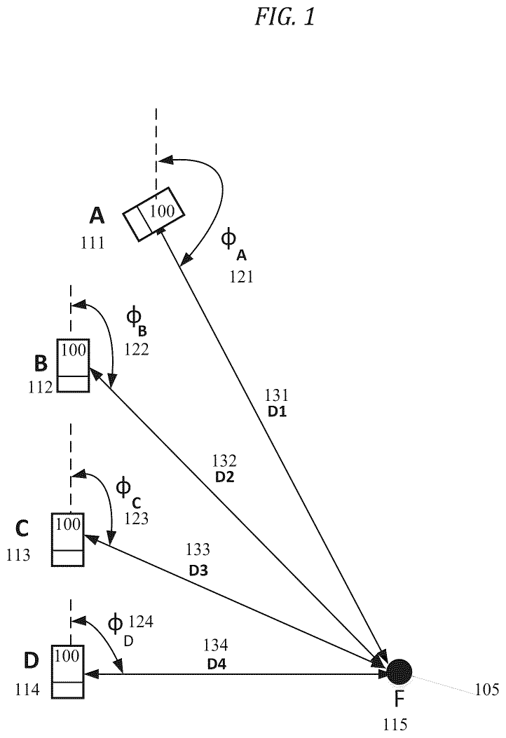

FIG. 1 is a diagram of an example wireless measuring station 100, moving from point A 111 to point D 114, via points B 112 and C 113, measuring RTTs and AOAs for a target station 105 located at point F 115. When wireless measuring station 100 is at point A 111, the measured RTT, RTT_{A}, will be related to distance D1 131, as discussed above with reference to equations (1), (2) and (3), and the measured AOA is φ_{A} 121. When wireless measuring station 100 is at point B 112, the measured RTT, RTT_{B}, will be related to distance D2 132, and the measured AOA is φ_{B} 122. Similarly, when wireless measuring station 100 is at points C 113 and D 114, the measured RTTs, RTT_{C} and RTT_{D}, will be related to distances D3 133 and D4 134, respectively, and the measured AOAs are φ_{C} 123 and φ_{D} 124.

In order to derive a location for target station 105, the best fit to the RTT measurements and to the AOA measurements may be determined. To better understand the present disclosure, and the attendant advantages and features thereof, a conventional method for fitting the RTT measurements to a target position by minimizing the sum of the squared residuals (SSR) is described with reference to FIG. 1.

Assume there are N measurements with index i of the RTT (i.e., RTTᵢ) from the wireless measuring station 100 to the target station 105. For an arbitrary target location, the RTT may be modelled by a function f(xᵢ, α) where vectors xᵢ are the known locations of the wireless measuring station 100 (e.g., latitude,

$${x}_{i}^{L A T} ,$$

longitude,

$${x}_{i}^{L O N} ,$$

and altitude,

$${x}_{i}^{A L T} )$$

and where parameter vector α defines the estimated location of the target station 105 (e.g., in terms of latitude, α^{LAT}, and longitude, α^{LON}, and altitude, α^{ALT}) plus additional parameters that may include a turnaround offset, α^{OFF}, to be determined. In some examples, α^{OFF} corresponds to the packet turnaround time at the target station 105.

The target location, α^{LAT}, α^{LON}, α^{ALT} and turnaround offset α^{OFF}, may be determined by first defining a squared residual, SR(rtt)ᵢ. SR(rtt)ᵢ is the square of the difference between the measurement of RTTᵢ and the computation of total travel time, ƒ(xᵢ,α), as shown in equation (4):

$${SR ( rtt )}_{i} = {[ {RTT}_{i} - f ( {x}_{i} , α ) ]}^{2} . \qquad ( 4 )$$

In equation (4), [RTTᵢ−ƒ(xᵢ,α)] is the residual R(rtt)ᵢ defined as the difference of RTTᵢ from the computed distance multiplied by the factor (2/c) and modified by an offset to convert that distance to a model RTT, as shown in equation (5):

$$f ( {x}_{i} , α ) = {α}^{O F F} + \frac{2}{c} ( d ( {x}_{i} , α ) ) . \qquad ( 5 )$$

The term d(xᵢ,α) in equation (5) is calculated as shown in equation (6): PGP-30E

$$d ( {x}_{i} , α ) = {[ {( {x}_{i}^{L A T} - {α}^{L A T} )}^{2} + {( ( {x}_{i}^{L 0 N} - {α}^{LON} ) * cos ( {x}_{i}^{L A T} ) )}^{2} + {( {x}_{i}^{A L T} - {α}^{A L T} )}^{2} ]}^{\frac{1}{2}} . \qquad ( 6 )$$

It is further noted that the speed of light c is in units of geographic distance divided by the units of RTT. For example, if latitude and longitude are used for location and microseconds are used for RTT, then c=0.0027027 degrees/microsecond. Longitude distances may be scaled by the cosine of the latitude to account for spherical coordinates. Additionally, the distances may be sufficiently small to use planar approximation.

If the errors in the RTT measurements are Gaussian, then the best value for the target location parameters, α, may be obtained by minimizing the sum of the squared residuals SSR(rtt)=ΣᵢS R(rtt)ᵢ, which is defined by setting the gradient of the SSR to zero, as shown in equation

$$0 = {∇}_{α} ( {\sum }_{i} S {R}_{i} ) = - 2 {\sum }_{i} [ R T {T}_{i} - f ( {x}_{i} , {α}_{i} ) ] [ {∇}_{\overline{α}} f ( {x}_{i} , α ) ] . \qquad ( 7 )$$

A Jacobian J_{iα} may be defined as J_{iα}=∇_{α}ƒ(xᵢ,α). The Jacobian J_{iα} may be used to define the direction to a minimum, known as the Steepest Descent method. Then, the Levenberg-Marquardt algorithm may be used, which interpolates between the Steepest Descent method initially and the Gauss-Newton method once close to the minimum.

Once this minimum is found, then the confidence ellipse, known as the circular error probability (CEP) ellipse, may be found using the Jacobian J_{iα} evaluated with the parameter values determined by the best fit. In the first step, the Hessian H_{α′α} may approximately be defined by equation (8):

$${H}_{{α}^{′} α} = {\sum }_{i} {[ {J}_{i {α}^{′}} ]}^{T} {J}_{i α} . \qquad ( 8 )$$

A correlation matrix ρ_{α′α} is defined as the inverse of the Hessian H_{α′α}, as shown in equation (9):

$${ρ}_{{α}^{′} α} = {H}_{{α}^{′} α}^{- 1} . \qquad ( 9 )$$

Then, a CEP ellipse, comprising length, width and orientation (θ), may be defined for the resulting location, as shown in Table 1 below:

### Location Confidence Ellipse Parameters

TABLE 1

| | |
|---|---|
| Major axis | Length² = ρ₀₀ * Cos(θ) + ρ₁₁ * Sin(θ) * Sin(θ) + 2 * ρ₀₁ * Cos(θ) * Sin(θ) |
| Minor axis | Width² = ρ₁₁ * Cos(θ) * Cos(θ) + ρ₀₀ * Sin(θ) * Sin(θ) + 2 * ρ₀₁ * Cos(θ) * Sin(θ) |
| Orientation | Tan(2θ) = 2 * ρ₀₁/(ρ₀₀ − ρ₁₁) |

As discussed above, a conventional technique for determining the best fit to function ƒ(xᵢ,α) is by minimizing the sum of squared residuals, SSR, also known as the least squared residuals. For non-linear functions, such as ƒ(xᵢ,α), there are various iterative methods that may be used, including those known as Steepest Descent, Gauss-Newton, and Levenberg-Marquardt.

Similarly, the method for fitting the AOA measurements to a target position may be achieved with the use of minimization of the SSR, as follows.

Assume there are N measurements with index i of the AOA (i.e., φᵢ) from the measuring station 100 to the target station 105. For an arbitrary target location, the AOA may be modelled by a function ƒ(xᵢ,β) where vectors xᵢ are the known positions of the measuring station 100 (e.g., in terms of latitude

$${x}_{l}^{L A T} ,$$

longitude

$${x}_{i}^{L O N} ,$$

and altitude

$${x}_{i}^{A L T} ) ,$$

and where parameter vector β defines the AOA of the signal from target station 105.

The AOA may be determined by first defining a square residual, SR(aoa)ᵢ where SR(aoa)ᵢ is the square of the difference between the measurement of AOA, φᵢ, and the computation of modelled AOA, ƒ(xᵢ,β), as shown in equation (10) below:

$${SR ( aoa )}_{i} = {[ {ϕ}_{i} - f ( {x}_{i} , β ) ]}^{2} . \qquad ( 10 )$$

In equation (10), the term [φᵢ−ƒ(xᵢ,β)] is the residual R(aoa), defined as the difference of the measured AOA φᵢ, from the computed AOA, and the term ƒ(xᵢ,β), as defined by equation (11):

$$f ( {x}_{i} , β ) = A TAN ( \frac{( {α}^{LON} - {x}_{i}^{L 0 N} ) * cos ( {x}_{i}^{LAT} )}{( {α}^{LAT} - {x}_{i}^{LAT} )} ) . \qquad ( 11 )$$

In equation (10), the value of φᵢ−ƒ(xᵢ,β) may be a multiple of 360 degrees. In such cases, this may be corrected by replacing φᵢ−ƒ(xᵢ,β) with the expression ASIN(SIN((φᵢ−ƒ(xᵢ,β))/2)).

Similar to RTT errors, if the errors in the AOA measurements are Gaussian, then the best value for the target AOA parameters, β, may be obtained by minimizing the SSR, which is defined by setting the gradient of the SSR to zero. Once this minimum is found, the CEP ellipse comprising length, width, and orientation (θ) may be defined, similar to the method as discussed above for RTTs.

If the errors in the RTT and AOA measurements are Gaussian, then the Levenberg-Marquardt algorithm will handle the errors, and a true minimum can be found. In such a case, the CEP ellipses for the RTT and the AOA might be expected to coincide and be in agreement. However, the RTT and AOA measurements may exhibit independent systematic errors. These systematic errors can result in the calculated RTT and/or AOA ellipses changing in position and/or size from measurement to measurement. Hence, at any one point in a series of measurements, the individual histories of the CEP ellipses' locations and size may change due to systematic errors. Selecting whether to merge the CEP ellipses, or whether to display one CEP ellipse or the other, may require the determination of the relative residuals' errors and the amount of agreement between the CEP ellipses.

Accordingly, methods and apparatuses are disclosed herein for determining the best CEP ellipse to be displayed based upon the individual and combined RTT and AOA CEP ellipses in the possible presence of systematic errors. The method may be used to analyze when either one, or both CEP ellipses have systematic errors that would degrade the accuracy of the displayed CEP ellipse. The method may determine that it is better to either (i) not include such a CEP ellipse in the analysis or (ii) that both CEP ellipses are accurate and can be merged into a single CEP ellipse. In other words, if either CEP ellipse (i.e., the RTT or AOA CEP ellipse) is subject to systematic errors, it should not contribute to the displayed CEP ellipse, subject to the degree of errors.

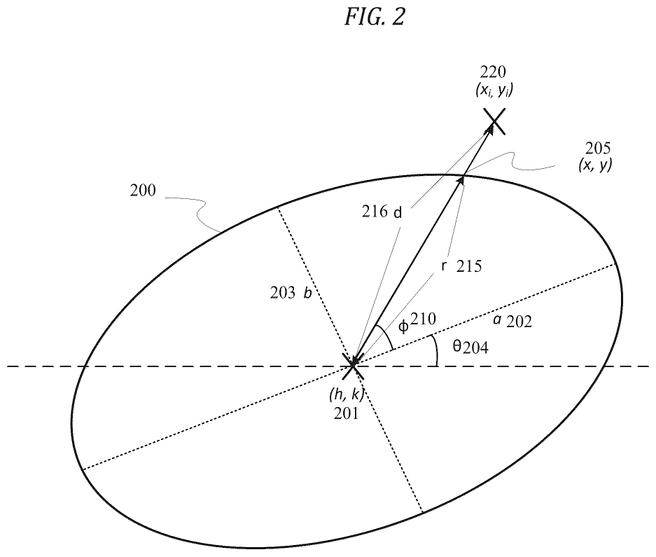

A measurement of the “closeness” or “agreement” of two CEP ellipses can be defined as the “relative separation” between their centers compared to the ellipse radius. FIG. 2 is a diagram of an example first CEP ellipse 200, centered at position (h, k) 201, with a major axis a 202, a minor axis b 203, and an offset angle (i.e., orientation) θ 204. Position (xᵢ, yᵢ) 220 is the center of a second CEP ellipse (not shown). The distance between the two centers, (h, k) 201 and (xᵢ, yᵢ) 220, is d 216. Position (xᵢ, yᵢ) 220 is at an angle φ 210 to the major axis a 202. At angle φ 210, the radius of the ellipse 200 is r 215. The relative separation (RS) is provided by equation (12):

$$RS = d / r . \qquad ( 12 )$$

If RS>1, then the center (xᵢ, yᵢ) 220 is outside the ellipse 200. If RS<1, then the center (xᵢ, yᵢ) 220 is inside the ellipse 200.

The constraint equation for an ellipse with major axis a and minor axis b is provided by equation (13):

$${( \frac{x}{a} )}^{2} + {( \frac{y}{b} )}^{2} = 1. \qquad ( 13 )$$

The x, y parameters of an ellipse with zero offset angle (i.e., θ=0) may be expressed in parametric terms, as provided by equation (14):

$$\begin{matrix}x = r cos ϕ & y = r sin ϕ\end{matrix} . \qquad ( 14 )$$

The constraint equation for an ellipse with major axis a, minor axis b, offset θ and centered at location (h, k) 201 is provided by equation (15):

$$\frac{{[ \{ x - h ) cos θ + ( y - k ) sin θ ]}^{2}}{{a}^{2}} + \frac{{[ \{ x - h ) sin θ + ( y - k ) cos θ ]}^{2}}{{b}^{2}} = 1. \qquad ( 15 )$$

Substituting the parametric terms in equation (14), equation (15) can be expressed as shown in equation (16):

$$\frac{{[ r cos ϕcosθ + r sin ϕsinθ ]}^{2}}{{a}^{2}} + \frac{{[ r cos ϕsinθ + r sin ϕcosθ ]}^{2}}{{b}^{2}} = 1. \qquad ( 16 )$$

Equation (16) can then be expressed as shown in equation (17):

$$\frac{{[ r ( cos ( ϕ - θ ) ]}^{2}}{{a}^{2}} + \frac{{[ r sin ( θ - ϕ ) ]}^{2}}{{b}^{2}} = 1. \qquad ( 17 )$$

From equation (17), the value for the radius r 215 is provided by equation (18):

$$r = \sqrt{\frac{1}{( \frac{{Cos ( ϕ - θ )}^{2}}{{a}^{2}} + \frac{{Sin ( θ - ϕ )}^{2}}{{b}^{2}} )}} . \qquad ( 18 )$$

Referring again to FIG. 2, the value of angle @210 is provided by equation (19):

$$ϕ = A TAN ( \frac{{y}_{i}}{{x}_{i}} ) - θ . \qquad ( 19 )$$

The value of d 216 is provided by equation (20):

$$d = \sqrt{{( {x}_{i} - h )}^{2} + {( {y}_{i} - k )}^{2}} . \qquad ( 20 )$$

From equations (18), (19) and (20), the RS can be calculated as provided by equation (21):

$$RS = \frac{d}{r} = \sqrt{[ {( {x}_{i} - h )}^{2} + {( {y}_{i} - k )}^{2} ] ( \frac{{Cos ( ϕ - θ )}^{2}}{{a}^{2}} + \frac{{Sin ( θ - ϕ )}^{2}}{{b}^{2}} )} . \qquad ( 21 )$$

The RS value provides a measurement of the closeness or agreement between two CEP ellipses and may be used to evaluate if systematic errors are present. For example, when the dimensions of the latest CEP ellipse are calculated, as discussed above with reference to equations (4) to (9) and Table 1, the RS may be calculated for the center of the latest CEP ellipse against each of M previous CEP ellipses. The average RS, RSₐᵥₑ, may then be calculated and used as a measurement of the agreement of the set of CEP ellipses. For example, if RSₐᵥₑ is less than a preset value R, then that set of ellipses may be considered as being in agreement and hence the latest CEP ellipse may be considered “good” or “acceptable”. Conversely, if the RSₐᵥₑ is greater than R, then that that set of ellipses may be considered as not being in agreement and the latest CEP may be considered “unacceptable”. By way of example and not limitation, M may have a value of 3 and R may have a value of 1.

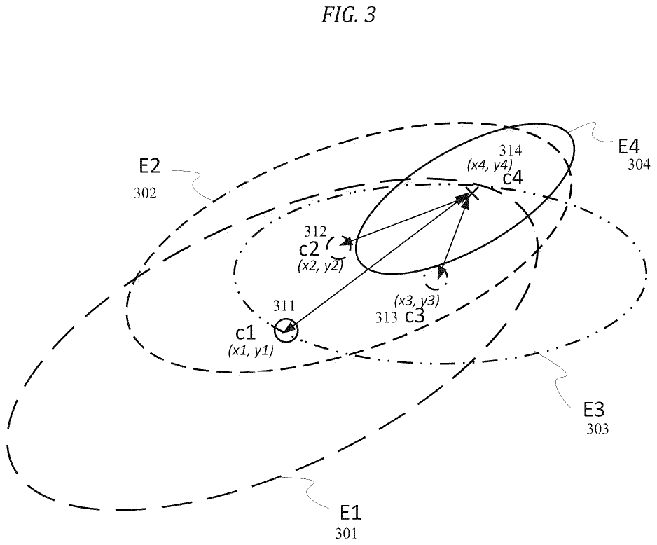

FIG. 3 is a schematic diagram of an example set of four consecutive CEP ellipses, E1 301, E2 302, E3 303, and E4 304, where E4 304 is the latest CEP ellipse. The centers of the CEP ellipses E1 301, E2 302, E3 303, and E4 304, are c1 311, c2 312, c3 313, and c4 314 respectively. The RS for the center c4 314 of the latest CEP ellipse E4 304 against each of the other CEP ellipses may be calculated. As the center c4 314 is inside each of the three CEP ellipses E1 301, E2 302, and E3 303, the RS value against each CEP ellipse is less than 1 and hence the value of RSₐᵥₑ is also less than 1. In the example depicted in FIG. 3, the RS values for the center c4 314 of CEP ellipse E4 304 against the other example CEP ellipses, E1 301, E2 302, and E3 303, are 0.95, 0.6, and 0.95, respectively, and hence the value of RSₐᵥₑ is 0.83. Therefore, in this example, as RSₐᵥₑ is less than 1, the set of CEP ellipses depicted in FIG. 3 may be considered as being in agreement and the latest CEP ellipse E4 304 may be considered good, or acceptable.

A stability factor, SF, for a set of CEP ellipses can be defined as provided by equation (22):

$$SF = 10 * {e}^{- {RS}_{ave}} . \qquad ( 22 )$$

For example, the set of CEP ellipses depicted in FIG. 3 have an SF of 4.36. The higher the SF, the more stable the set of CEP ellipses. For an RSₐᵥₑ value of 1, the SF value is 3.68. An SF value of F may be used as the threshold for agreement between sets of CEP ellipses. By way of example and not limitation, F may have a value of 3.5.

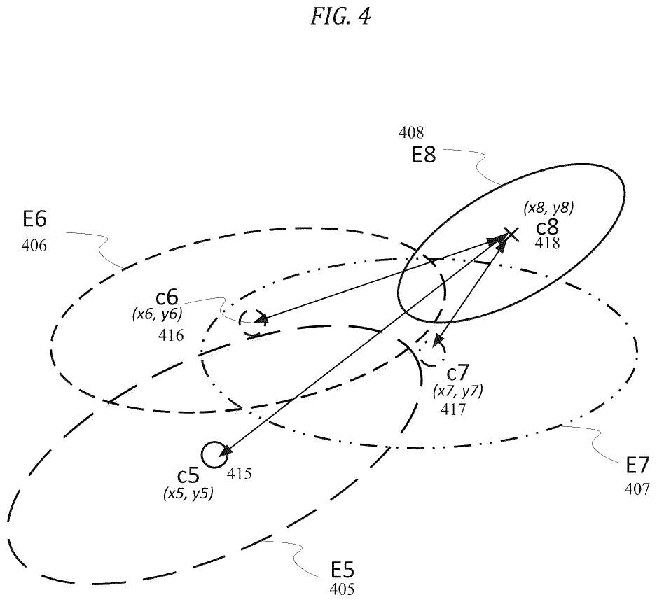

FIG. 4 is a schematic diagram of another example set of consecutive CEP ellipses, E5 405, E6 406, E7 407, and E8 408, where E8 408 is the latest CEP ellipse. The centers of the CEP ellipses, E5 405, E6 406, E7 407, and E8 408, are c5 415, c6 416, c7 417, and c8 418 respectively. The RS for the center c8 418 of the latest CEP ellipse E8 408 against each of the other CEP ellipses may be calculated. As the center c8 418 is outside each of the three CEP ellipses E5 405, E6 406, and E7 407, the RS value against each CEP ellipse is greater than 1 and hence the value of RSₐᵥₑ is also greater than 1. The RS values for the center c8 418 of CEP ellipse E8 408, against the other example CEP ellipses, E5 405, E6 406, and E7 407, in FIG. 4 are 1.8, 1.4, and 1.2, respectively, providing an RSₐᵥₑ value of 1.47 and an SF value of 2.3. As the SF value is less than 3.5, the set of CEP ellipses depicted in FIG. 4 may be considered to not be in agreement and the latest CEP ellipse E8 408 is not acceptable.

In one embodiment, the SFs for the latest RTT and AOA CEP ellipses are determined against the M previous RTT and AOA CEP ellipses, RTT SF and AOA SF respectively. The following criteria are then applied:
1. If neither RTT SF nor AOA SF is greater than F, then neither CEP is accepted nor displayed.
2. If only RTT SF is greater than F, then the RTT CEP ellipse is accepted and displayed.
3. If only the AOA SF is greater than F, then the AOA CEP ellipse is accepted and displayed.
4. If both RTT SF and AOA SF are greater than F, then both CEP ellipses are considered acceptable and the ellipses are examined further.

In one embodiment, in the case of criteria (4) above being met, the CEP ellipses may then be further examined to assess if the latest RTT and AOA CEP ellipses are in agreement with each other.

If the RSs between the CEP ellipses are sufficiently small, the merging algorithm is accurate, if not, then the merging algorithm should not be used. The merging algorithm replaces the actual sum square residuals, SSR, by the multi-dimensional quadratic functions of the parameters squared (i.e., all the matrix terms). The total SSR is then approximated by sum of the Hessians from the multiple CEPs. However, if the points are distant from the center, the quadratic with Hessian coefficients does not accurately represent the true original SSRs and the total SSRs should not be used for points that are greater than the ellipse from the center (i.e., RS of 1). Therefore, if the RS value of the center of the larger CEP ellipse to the smaller CEP ellipse is less than S, and the RS value of the center of the smaller CEP ellipse to the larger CEP ellipse is less than U, then the two CEP ellipses may be considered to be in agreement and may be merged. The size of a CEP ellipse may be determined by the length of its major axis. By way of example and not limitation, S may have a value of 1.5 and U may have a value of 1.

A lower value for S may be considered when the sizes of the two CEP ellipses are close. For example, if the two CEP ellipses are equal in size, then S may take a value of 1. In one embodiment, if the length of the larger CEP ellipse major axis is a₁, and the length of the smaller CEP ellipse major axis is a₂, then the value of S may be provided by equation (23):

$$\begin{matrix}1 < \frac{{a}_{1}}{{a}_{2}} < 1.5 & S = \frac{{a}_{1}}{{a}_{2}}\end{matrix} \qquad ( 23 )$$

$$\begin{matrix}\frac{{a}_{1}}{{a}_{2}} \geq 1.5 & S = 1.5\end{matrix} .$$

A further check may be made to determine the agreement between the merged CEP ellipse and the contributing RTT and AOA CEP ellipses to ensure that the merged CEP encompasses both CEP ellipse centers. If the RS values between the merged CEP ellipse and each of the AOA and RTT ellipses are both less than a preset value V, then the merged CEP may be considered to be acceptable and may be displayed. If either of the RS values is greater than V, then the merged CEP ellipse is considered to not be acceptable. By way of example and not limitation, V may have a value of 0.75.

If the RS value of the center of the larger CEP ellipse to the smaller CEP ellipse is greater than S, or the RS value of the center of the smaller CEP ellipse to the larger CEP ellipse is greater than U, then the two CEP ellipses may be considered to not be in agreement. In this case, and also in the case that the merged CEP ellipse is not acceptable, the CEP ellipse, RTT or AOA, with the higher SF is selected and if the SF is greater than a preset value K, it is displayed. By way of example and not limitation, K may have a value of 5. In the case where there is disagreement between the RTT and AOA CEP ellipses which both have SFs greater than F (e.g., 3.5), it may be required that the higher SF is greater than K (e.g., 5) to be displayed.

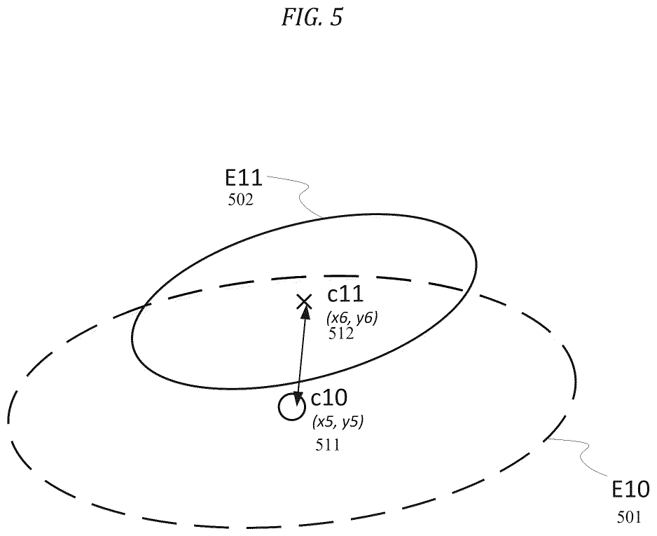

FIG. 5 is a schematic diagram of an example of a larger CEP ellipse E10 501 and a smaller CEP ellipse E11 502. The centers of the CEP ellipses E10 501 and E11 502 are c10 511 and c11 512, respectively. In this example, the two CEP ellipses, E10 501 and E11 502, may represent RTT and AOA CEP ellipses that individually have RS values greater than F (e.g., 3.5) and are being further assessed to determine if there is agreement between them. In this example, the RS value between the center c10 511 and the smaller CEP ellipse center c11 512, compared to the larger CEP ellipse E10 501 is 0.8, and the RS value between the center c11 512 and the larger CEP ellipse center c10 511, compared to the smaller ellipse E11 502, is 1.3. In one example, the two CEP ellipses, E10 501 and E11 502, pass nominal RS thresholds of S=1.5 and U=1, and therefore may be judged to be in agreement and may be merged.

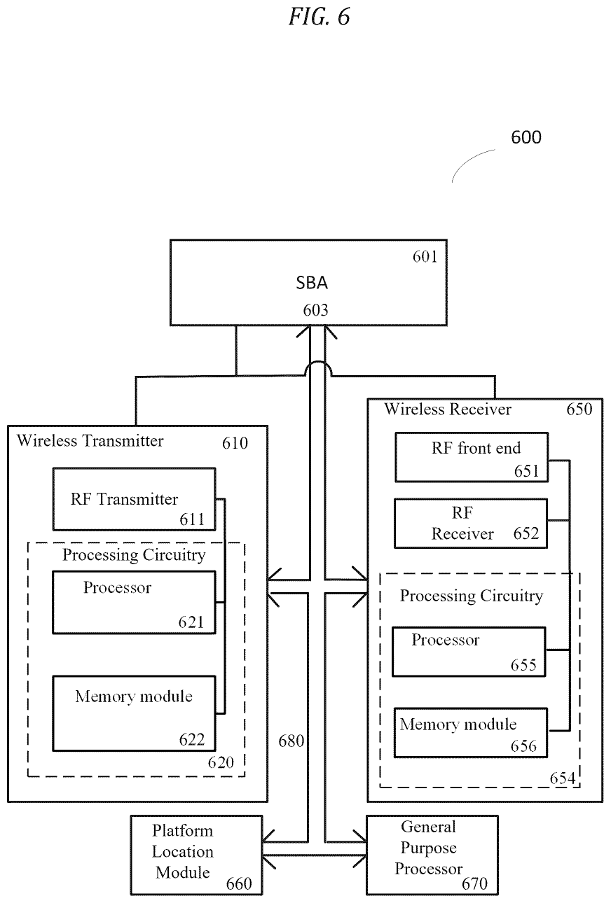

FIG. 6 illustrates a block diagram of an example wireless communication device 600. In some embodiments, the wireless communication device 600 may be used as, or as part of, the wireless measuring station 100. Wireless communication device 600 may be any device capable of wirelessly receiving signals and transmitting signals and may be configured to execute any of the methods of signals of interest (e.g., IEEE 802.11 (Wi-Fi), Bluetooth® technology, etc.). Wireless communication device 600 may be one or more stations, access points or masters, and the like. Wireless communication device 600 may be one or more wireless devices that are based upon the IEEE 802.11-2020 specification and each may be configured to act as a transmitter or a receiver. Wireless communication device 600 may be one or more wireless devices that are based upon the Bluetooth® Specification and each may be configured to act as a transmitter or a receiver. In one embodiment described herein, wireless communication device 600 includes a switched beam antenna (SBA) 601, a wireless transmitter 610, and a wireless receiver 650. By way of example and not limitation, the wireless communication device 600 can also include a platform location module 660 and a general purpose processor 670 interconnected to the wireless transmitter 610, the wireless receiver 650, and the SBA 601 by a data bus 680. In some embodiments, the connection to the SBA 601 via communications connector 603 can be established via a separate data bus from the processing circuitry used to control the SBA 601, i.e., via processing circuitry 620 or 654, or the general purpose processor 670.

In some embodiments, the wireless transmitter 610 includes a radio frequency (RF) transmitter 611 and processing circuitry 620 that includes a processor 621 and a memory module 622. The RF transmitter 611 may perform the functions of modulation and amplification for the transmission of packets via the SBA 601. In some embodiments, the processing circuitry 620 and/or the processor 621 include integrated circuitry to process and/or control, for example, one or more processors, processor cores, Field Programmable Gate Arrays (FPGAs), and/or Application Specific Integrated Circuitry (ASICs), each configured to execute programmatic software instructions. In some embodiments, the processing circuitry 620 may perform the functions of the RF transmitter 611. The processing circuitry 620 can be configured to control any of the methods or processes described herein and to cause such methods or processes to be performed (e.g., by the RF transmitter 611). The memory module 622 can be configured to store data, programmatic software code, and/or other information described herein. In some embodiments, the software includes instructions that, when executed by the processing circuitry 620, cause the processing circuitry 620 to perform the processes described herein with respect to the wireless transmitter 610.

In some embodiments, the RF transmitter 611 is configured to transmit signals and the processing circuitry 620 is configured to prepare the transmitted signal attributes based upon, for example, the IEEE 802.11-2020 standard, the Bluetooth® system standard, or the like. Such transmitted packets may include data packets, control packets, and management packets. Such control packets may include RTS packets, paging, and polls. The memory module 622 may store instructions for executing any method mentioned in the present disclosure, parameters for input signals, results processed by the processor 621, parameters for signals to be outputted, and the like.

In some embodiments, the wireless receiver 650 includes an RF front end 651, an RF receiver 652, and processing circuitry 654 that includes a processor 655 and a memory module 656. The RF front end 451 can perform functions of an RF receiver front end, such as low noise amplification, filtering, and frequency down conversion so as to condition the received signal suitable for inputting to the RF receiver 652. The RF receiver 652 may demodulate the packets received via SBA 601 and RF front-end 651.

In some embodiments, the RF receiver 652 and/or the processing circuitry 654 include integrated circuitry to process and/or control, for example, one or more processors, processor cores, FPGAs, and/or ASICs, each configured to execute programmatic software instructions. In some embodiments, the functions of the RF receiver 652 are performed by the processing circuitry 654. The processing circuitry 654 can be configured to control any of the methods or processes described herein and to cause such methods or processes to be performed, for example, by the wireless receiver 650. The memory module 656 is configured to store data, programmatic software code, and other information described herein. In some embodiments, the software includes instructions that, when executed by the processing circuitry 654, causes the processing circuitry 654 to perform the processes described herein with respect to the wireless receiver 650.

According to some embodiments, the wireless receiver 650 is configured to measure and monitor an input signal's attributes, such as one or more of (i) a signal transmitted by wireless transmitter 610, (ii) data and control packets, and (iii) response signals, including control packets, transmitted by a station, access point, master, or slave. Such data, control, and response packets may include data null, ACK, RTS, CTS, Null, or Poll packets. The memory module 656 may store instructions for executing any method mentioned in the relevant standard(s) of the signal(s) of interest, input signals, and processing results from the processor 655, signals to be outputted, and the like. The processing circuitry 654 can output attributes of the exchange of packets to the general purpose processor 670, such as signal strength together with the antenna beam that was selected in the SBA 601 in order to control the SBA 601 and determine the AOA of the received signal from the target station 105. Processing circuitry 654 can also output to the general purpose processor 670 attributes, such as identity and time of the signals transmitted by wireless transmitter 610 and the signals received by the wireless receiver 650, in order to determine the RTT between the wireless communication device 600 (i.e., the measuring station 100) and the target station 105.

According to some embodiments, the processing circuitry 654 may also determine the value of the signal strengths of packets from the other wireless communication device and the time of arrivals. The signal strengths may be used to determine the next antenna beam to be selected in SBA 601 and the derivation of the AOA.

According to some embodiments, the wireless transmitter 610 is configured to transmit bursts of packets to another wireless communication device, and the processor 621 is configured to prepare the attributes of the packets. The processor 621 may also be configured to control the SBA 601 to select an antenna beam for the next burst of transmissions.

According to some embodiments, the general purpose processor 670 is used to control the operations of the wireless communication device 600 and in particular the wireless transmitter 610 and wireless receiver 650. The general purpose processor 670 may provide an interface to a user, for example, via a keyboard, mouse, and display, allowing a user to select the attributes of the target station 105, control the start and stop times of transmitted packets, and interpret the resulting RTTs and AOAs. The general purpose processor 670 may also carry out the various calculations as described in this disclosure, such as determining a location CEP ellipse for a target station 105 based upon the resulting RTTs and AOAs, and may also prepare the measurement results to be presented to an operator or user. The general purpose processor 670 may also carry out the various calculations as described in this disclosure, such as determining the RS values of CEP ellipses. In some embodiments, the general purpose processor 670 may include integrated circuitry for processing and/or controlling, e.g., one or more processors, processor cores, FPGAs, and/or ASICs configured to execute programmatic software instructions, and may include a memory module to execute programmatic code stored in the general purpose processor or another device. The elements of the wireless communication device 600 can be included in a single physical device/housing or be distributed among several different physical devices/housings.

According to some embodiments, a platform location module 660 inputs the location of the platform that is carrying the wireless communication device 600, via the data bus 680, to the general purpose processor 670 and/or the processing circuitry 620 and/or 654. The platform location module 660 may include navigation equipment, such as a Global Positioning System (GPS) receiver and/or a gyroscope and may provide both the location and heading direction of the wireless communication device 600 to the general purpose processor 670 and/or processing circuitries 620 and 654. The location and heading direction of the wireless communication device 600, together with the antenna selections of the SBA 601, the AOAs, and the measurements of RTT, may be used by the general purpose processor 670 to calculate and display a CEP ellipse of the location of the target station 105.

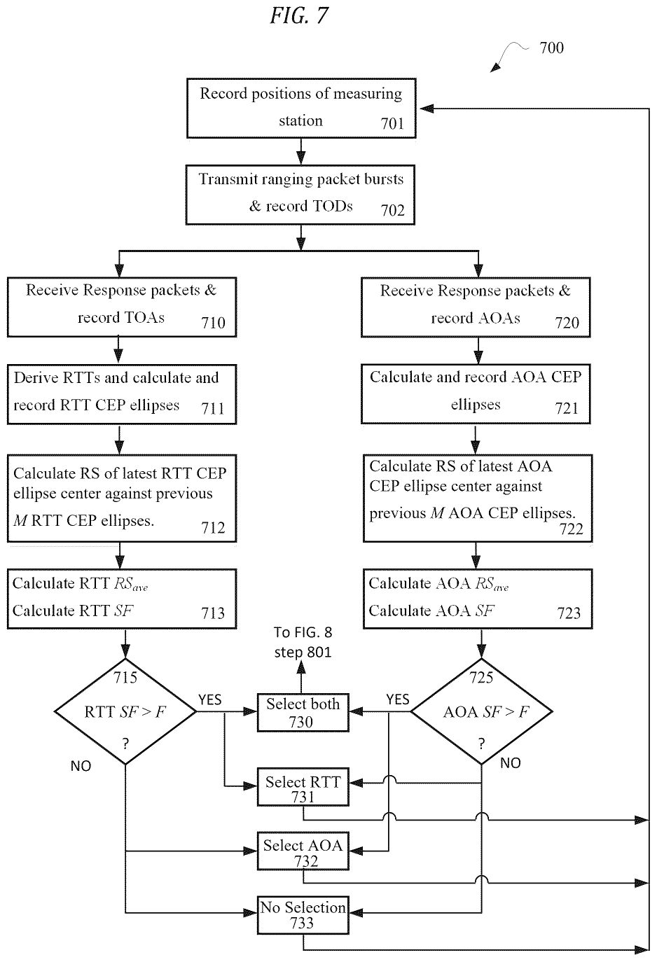

FIGS. 7, 8, 9, and 10 are flowcharts of an example process for determining the optimum CEP ellipse to be displayed when deriving both RTT and AOA CEP ellipses. In one example, the following values are used: M=3, F=3.5, S=1.5, U=1, V=0.75, K=5. It should be appreciated that these are exemplary values and may be adjusted based on implementation requirements.

FIG. 7 is a flowchart of a process 700 for determining the closeness or agreement between the latest set of RTT CEP ellipses and between the latest set of AOA CEP ellipses. At step 701, the positions of the wireless measuring station 100 are recorded. At step 702, the wireless measuring station 100 transmits bursts of ranging packets and the TODs are recorded. At step 710, the times of the received response packets (i.e., the TOAs) are recorded. At step 711, the RTTs for each of the ranging and response packet exchanges are derived, and the RTT CEP ellipses calculated. Step 720 also follows step 702. At step 720, the AOAs for each of the response packets are derived and recorded. At step 721, the AOA CEP ellipses are calculated. In some examples, steps 701, 702, 710, 711, 720, and 721 correspond to the steps discussed above with reference to FIG. 6 that the wireless communication device 600 (i.e., wireless measuring station 100) uses to transmit ranging packets, receive response packets, measure the AOA, and calculate the RTT for each set of packet exchanges.

Step 712 follows step 711. At step 712, as discussed above with reference to FIGS. 3 and 4, and equation (12), the RS value is calculated for the center of the latest RTT CEP ellipse against each of the previous M RTT CEP ellipses. Then, at step 713, the average RTT RS value, RTT RSₐᵥₑ, and the RTT SF value are calculated.

Step 722 follows step 721. At step 722, as discussed above with reference to FIGS. 3 and 4, and equation (12), the RS value is calculated for the center of the latest AOA CEP ellipse against each of the previous M AOA CEP ellipses. Then, at step 723, the average AOA RS value, AOA RSₐᵥₑ, and the AOA SF value are calculated.

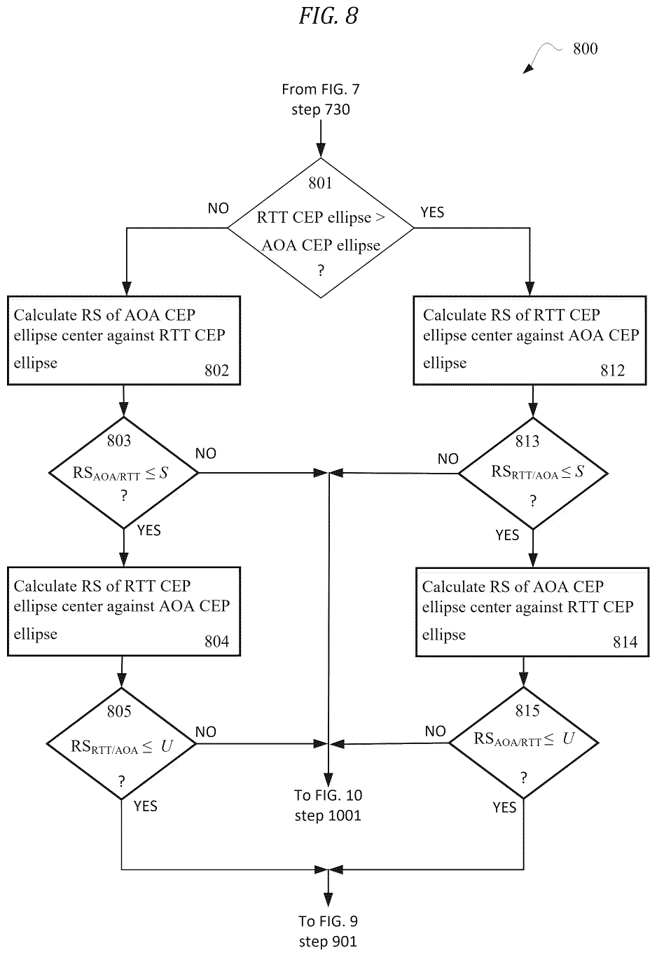

At steps 715 and 725, the values of RTT SF and AOA SF, respectively, are checked and if both are greater than F, then at step 730, both the RTT and the AOA CEP ellipses are selected, and the process proceeds to process 800 (i.e., FIG. 8 step 801).

If, at step 715 the RTT SF value is greater than F, and at step 725, the AOA SF value is less than F, then, at step 731, the RTT CEP ellipse is selected for display, and the process returns to step 701.

If, at step 715 the RTT SF value is less than F, and at step 725 the AOA SF value is greater than F, then, at step 732, the AOA CEP ellipse is selected for display and the process returns to step 701.

If, at step 715 the RTT SF value is less than F, and at step 725 the AOA SF value is also less than F, then, at step 732, neither CEP ellipse is selected for display, and the process returns to step 701.

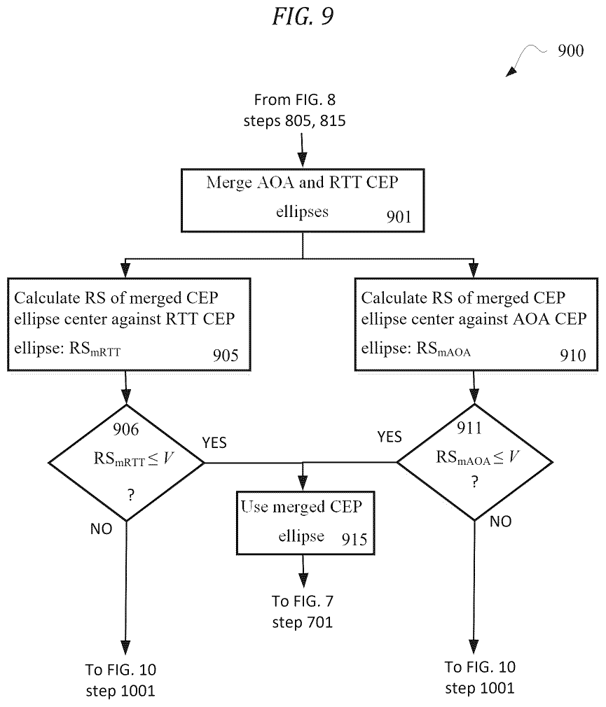

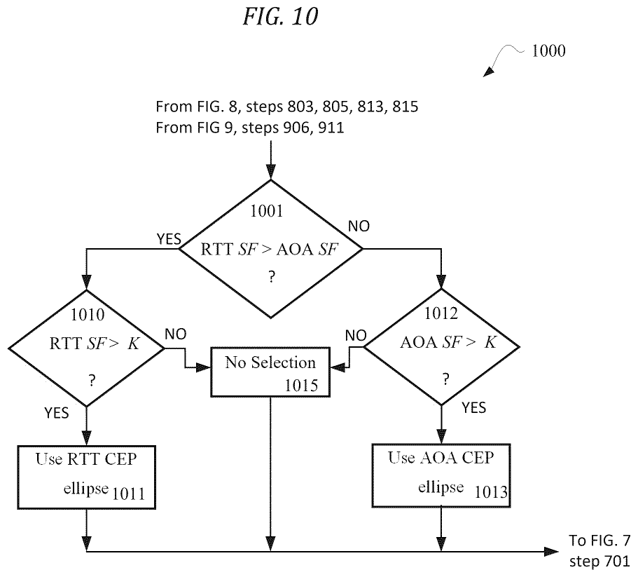

FIG. 8 is a flowchart of a process 800 for determining the closeness or agreement between the latest RTT and AOA CEP ellipses that each have SF values greater than F (e.g., as determined in process 700). In step 801, it is determined which CEP ellipse is larger. The larger CEP ellipse is that with the longer major axis (e.g., major axis a 202 of FIG. 2). If the RTT CEP ellipse is larger, then at step 812, the RS is calculated for the center of the RTT CEP ellipse against the AOA CEP ellipse, RS_{RTT/AOA}. At step 813, a check is made if the value of RS_{RTT/AOA} is less than or equal to S, and if true, then at step 814, the RS is calculated for the center of the AOA CEP ellipse against the RTT CEP ellipse, RS_{AOA/RTT}. At step 815, a check is made if the value of RS_{AOA/RTT} is less than or equal to U, and if true, the process continues to process 900 (i.e., FIG. 9 step 901). If at step 813, the value of RS_{RTT/AOA} is greater than S, or at step 815 the value of RS_{AOA/RTT} is greater than U, then the process continues to process 1000 (i.e., FIG. 10 step 1001).

At step 801, if the AOA CEP ellipse is the larger ellipse, then at step 802, the RS is calculated for the center of the AOA CEP ellipse against the RTT CEP ellipse, RS_{AOA/RTT}. At step 803, a check is made if the value of RS_{AOA/RTT} is less than or equal to S, and if true, then at step 804, the RS is calculated for the center of the RTT CEP ellipse against the RTT CEP ellipse, RS_{RTT/AOA}. At step 805, a check is made if the value of RS_{RTT/AOA} is less than or equal to U, and if true, the process continues to process 900 (i.e., FIG. 9 step 901). If at step 803, the value of RS_{RTT/AOA} is greater than S, or at step 805, the value of RS_{AOA/RTT} is greater than U, then the process continues to process 1000 (i.e., FIG. 10 step 1001).

As discussed above with reference to FIG. 5, process 800 measures the closeness or agreement between the AOA CEP ellipse and the RTT CEP ellipse using the relative RS values. The two CEP ellipses are determined to be in agreement, and hence suitable for merging, if the RS of the larger CEP ellipse to the smaller is less than, or equal to S, and the RS of the smaller CEP ellipse to the larger is less than or equal to U. Hence, if the two CEP ellipses meet this criterion, they may be merged.

FIG. 9 is a flowchart of a process 900 for determining the closeness or agreement between the merged CEP ellipse and the latest RTT and AOA CEP ellipses. At step 901, the AOA and RTT CEP ellipses are merged. At step 905, the RS of the center of the merged CEP ellipse against the RTT CEP ellipse, RS_{mRTT}, is calculated. At step 906, a check is made if the value of RS_{mRTT} is less than or equal to V. Similarly, at step 910, the RS of the center of the merged CEP ellipse against the AOA CEP ellipse, RS_{mAOA}, is calculated. At step 911, a check is made if the value of RS_{mAOA} is less than or equal to V. If at steps 906 and 911, it is determined that both RS_{mRTT} and RS_{mAOA} are less than or equal to V, then at step 915, the merged CEP ellipse is selected and displayed. The process then returns to process 700 (i.e., FIG. 7 step 701). If, however, either RS_{mRTT} or RS_{mAOA} are greater than V, then the process continues to process 1000 (i.e., FIG. 10 step 1001).

Process 900 calculates the RSs of the merged CEP ellipse against the RTT and AOA CEP ellipses in order to check that the merged CEP ellipse is in agreement with both of them. The value of V=0.75 has been experimentally determined to represent good agreement and results in a merged CEP that is accurate.

FIG. 10 is a flowchart of a process 1000 that further selects either the AOA or RTT CEP ellipse, or neither. At step 1001, the SF values for the RTT and AOA CEP ellipses, RTT SF and AOA SF, respectively, calculated in steps 713 and 723 of process 700 are compared. If the RTT SF is greater than the AOA SF, then at step 1010, the value of RTT SF is further checked. If the value of RTT SF is greater than K, then at step 1011, the RTT CEP ellipse is selected and displayed, and the process returns to process 700 (i.e., FIG. 7, step 701). If the AOA SF is greater than the RTT SF, then at step 1012, the value of the AOA SF is further checked. If the value of AOA SF is greater than K, then at step 1013, the AOA CEP ellipse is selected and displayed, and the process returns to process 700 (i.e., FIG. 7, step 701). If at step 1010, the value of the RTT SF is less than K, or at step 1012, the value of AOA SF is less than K, then at step 1015, neither CEP ellipse is selected or displayed, and the process returns to process 700 (i.e., FIG. 7, step 701).

Process 1000 checks the SF values of the RTT and AOA CEP ellipses when it has been determined that either the two CEP ellipses are not in good agreement (e.g., as determined in process 800), or that the merged CEP ellipse is not in good agreement with both the RTT and AOA CEP ellipses (e.g., as determined in process 900). In these cases, an SF value of K is required (e.g., in steps 1011 and 1013) to select and display one of the CEP ellipses. In some examples, a threshold higher than the SF value of F that is used in process 700 is required, as process 1000 represents conditions that indicate a disagreement between the CEP ellipses that are generally rare, warranting a higher SF threshold.

### Some Embodiments

Some embodiments may include any of the following:

A1. A method for geo-locating a target station including transmitting, from a measuring station, a plurality of ranging packets to a target station; receiving, at the measuring station, a plurality of response packets transmitted by the target station in response to the plurality of ranging packets; determining a plurality of round trip times (RTTs) based on the plurality of ranging packets and the plurality of response packets; determining a plurality of angles of arrival (AOAs) based on the plurality of response packets; generating a plurality of RTT circular error probability (CEP) ellipses based on the plurality of RTTs; generating a plurality of AOA CEP ellipses based on the plurality of AOAs; calculating an RTT stability factor for a first RTT CEP ellipse, wherein the RTT stability factor indicates a level of agreement between the first RTT CEP ellipse and a preset number of immediately previous RTT CEP ellipses of the plurality of RTT CEP ellipses; calculating an AOA stability factor for a first AOA CEP ellipse, wherein the AOA stability factor indicates a level of agreement between the first AOA CEP ellipse and a preset number of immediately previous AOA CEP ellipses of the plurality of AOA CEP ellipses; comparing each of the RTT and AOA stability factors to a respective threshold; and based on at least one result of the comparisons, selecting either the first RTT CEP ellipse, the first AOA CEP ellipse, both CEP ellipses, or neither CEP ellipse for display to locate the target station.

A2. The method of clause A1 can include any of the following components or features, in any combination. The method includes calculating a plurality of RTT relative separation values for the first RTT CEP ellipse, wherein the plurality of RTT relative separation values indicate a level of separation between the first RTT CEP ellipse and each of the preset number of immediately previous RTT CEP ellipses of the plurality of RTT CEP ellipses; and calculating a plurality of AOA relative separation values for the first AOA CEP ellipse, wherein the plurality of AOA relative separation values indicate a level of separation between the first AOA CEP ellipse and each of the preset number of immediately previous AOA CEP ellipses of the plurality of AOA CEP ellipses. Calculating the RTT stability factor for the first RTT CEP ellipse is based on the plurality of RTT relative separation values, and calculating the AOA stability factor for the first AOA CEP ellipse is based on the plurality of AOA relative separation values. The RTT stability factor is calculated using an average of the plurality of RTT relative separation values and the AOA stability factor is calculated using an average of the plurality of AOA relative separation values. The first RTT and AOA CEP ellipses correspond to the RTT and AOA CEP ellipses generated from the RTT and AOA associated with a response packet most recently received by the measuring station. The method includes, in response to determining that the RTT stability factor exceeds the threshold and the AOA stability factor does not exceed the threshold, selecting the first RTT CEP ellipse for display to locate the target station; in response to determining that the AOA stability factor exceeds the threshold and the RTT stability factor does not exceed the threshold, selecting the first AOA CEP ellipse for display to locate the target station; and in response to determining that both the RTT and AOA stability factors exceed the threshold, selecting both the first RTT and AOA CEP ellipses for display to locate the target station. The method includes, in response to selecting both the first RTT and AOA CEP ellipses for display to locate the target station: determining which of the first RTT and AOA CEP ellipses is the larger; in response to determining that the first RTT CEP ellipse is the larger: calculating a first relative separation value for the first RTT CEP ellipse against the first AOA CEP ellipse; comparing the first relative separation value to a first threshold; in response to determining that the first relative separation value is greater than the first threshold, determining not to merge the first RTT and AOA CEP ellipses; in response to determining that the first relative separation value is less than or equal to the first threshold, calculating a second relative separation value for the first AOA CEP ellipse against the first RTT CEP ellipse; comparing the second relative separation value to a second threshold; in response to determining that the second relative separation value is greater than the second threshold, determining not to merge the first RTT and AOA CEP ellipses; and in response to determining that the second relative separation value is less than or equal to the second threshold, merging the first RTT and AOA CEP ellipses; and in response to determining that the first AOA CEP ellipse is the larger: calculating a third relative separation value for the first AOA CEP ellipse against the first RTT CEP ellipse; comparing the third relative separation value to the first threshold; in response to determining that the third relative separation value is greater than the first threshold, determining not to merge the first RTT and AOA CEP ellipses; in response to determining that the third relative separation value is less than or equal to the first threshold, calculating a fourth relative separation value for the first RTT CEP ellipse against the first AOA CEP ellipse; comparing the fourth relative separation value to the second threshold; in response to determining that the fourth relative separation value is greater than the second threshold, determining not to merge the first RTT and AOA CEP ellipses; and in response to determining that the fourth relative separation value is less than or equal to the second threshold, merging the first RTT and AOA CEP ellipses. The method includes, in response to determining not to merge the first RTT and AOA CEP ellipses: comparing the RTT stability factor to the AOA stability factor; in response to determining that the RTT stability factor is greater than the AOA stability factor: comparing the RTT stability factor to a third threshold; and in response to determining that the RTT stability factor is greater than the third threshold, selecting the first RTT CEP ellipse for display to locate the target station; and in response to determining that the AOA stability factor is greater than the RTT stability factor: comparing the AOA stability factor to the third threshold; and in response to determining that the AOA stability factor is greater than the third threshold, selecting the first AOA CEP ellipse for display to locate the target station. The method includes, in response to merging the first RTT and AOA CEP ellipses: calculating a fifth relative separation value for the merged CEP ellipse against the first RTT CEP ellipse; calculating a sixth relative separation value for the merged CEP ellipse against the first AOA CEP ellipse; comparing the fifth and sixth relative separation values to a third threshold; and in response to determining that at least one of the fifth and sixth relative separation values is less than or equal to the third threshold, selecting the merged CEP ellipse for display to locate the target station. The method includes in response to determining that both the fifth and sixth relative separation values are greater than the third threshold: comparing the RTT stability factor to the AOA stability factor; in response to determining that the RTT stability factor is greater than the AOA stability factor: comparing the RTT stability factor to a fourth threshold; and in response to determining that the RTT stability factor is greater than the fourth threshold, selecting the first RTT CEP ellipse for display to locate the target station; and in response to determining that the AOA stability factor is greater than the RTT stability factor: comparing the AOA stability factor to the fourth threshold; and in response to determining that the AOA stability factor is greater than the fourth threshold, selecting the first AOA CEP ellipse for display to locate the target station.

A3. A system configured to geo-locate a target station, the system comprising: at least one memory device with computer-executable instructions stored thereon; and at least one processor for executing the computer-executable instructions stored on the at least one memory device, wherein execution of the computer-executable instructions by the at least one processor causes the at least one processor to perform operations comprising: transmitting, from a measuring station, a plurality of ranging packets to a target station; receiving, at the measuring station, a plurality of response packets transmitted by the target station in response to the plurality of ranging packets; determining a plurality of round trip times (RTTs) based on the plurality of ranging packets and the plurality of response packets; determining a plurality of angles of arrival (AOAs) based on the plurality of response packets; generating a plurality of RTT circular error probability (CEP) ellipses based on the plurality of RTTs; generating a plurality of AOA CEP ellipses based on the plurality of AOAs; calculating an RTT stability factor for a first RTT CEP ellipse of the plurality of RTT CEP ellipses, wherein the RTT stability factor indicates a level of agreement between the first RTT CEP ellipse and all other RTT CEP ellipses of the plurality of RTT CEP ellipses; calculating an AOA stability factor for a first AOA CEP ellipse of the plurality of AOA CEP ellipses, wherein the AOA stability factor indicates a level of agreement between the first AOA CEP ellipse and all other AOA CEP ellipses of the plurality of AOA CEP ellipses; comparing each of the RTT and AOA stability factor values to a respective threshold; and based on a result of the comparison, selecting at least one of the first RTT and AOA CEP ellipses to locate the target station.

A4. A method in a measuring station for selecting and displaying the optimum confidence ellipse (CEP ellipse) when using round trip time (RTT) and angle of arrival (AOA) for the geo-locating of a target station. The method includes transmitting, from a measuring station, a plurality of ranging packets to a target station; receiving, at the measuring station, a plurality of response packets transmitted by the target station in response to the plurality of ranging packets; determining a plurality of RTTs based on the plurality of ranging packets and the plurality of response packets, each RTT of the plurality of RTTs being a time elapsed between a transmission of a ranging packet and a reception of a corresponding response packet; determining a plurality of AOAs based on the plurality of response packets, each AOA of the plurality of AOAs corresponding to an angle that a response packet was received at the measuring station; generating RTT CEP ellipses using the best-fit location RTT parameters for the target station; generating AOA CEP ellipses using the best-fit location AOA parameters for the target station; defining a parameter “relative separation” (RS) that measures the closeness or agreement between two CEP ellipses, the lower the RS value, the better the agreement between the two CEP ellipses; defining a parameter “stability factor” (SF) that is a measurement of the closeness or agreement between a set of CEP ellipses, the higher the SF value, the better the agreement between the set of CEP ellipses; calculating the SF value, SF_{RTT} for the latest RTT CEP ellipse against a number M of the previous RTT CEP ellipses; calculating the SF value, SF_{AOA}, for the latest AOA CEP ellipse against a number M of the previous AOA CEP ellipses; if the value of SF_{RTT} is higher than a preset threshold, F, and the value of SF_{AOA} is lower than the preset threshold F: selecting and displaying the RTT CEP ellipse; if the value of SF_{AOA} is higher than the preset threshold, F, and the value of RTT SF is lower than the preset threshold F: selecting and displaying the AOA CEP ellipse.

A5. The method of clause A4 can include any of the following components or features, in any combination. If the values of SF_{RTT} and SF_{AOA} are both higher than the preset threshold, F; measuring the RS between the RTT CEP ellipse and the AOA CEP ellipse, RS_{RTT/AOA}; measuring the RS between the AOA CEP ellipse and the RTT CEP ellipse, RS_{AOA/RTT}; if the values of both RS_{RTT/AOA} and RS_{AOA/RTT} pass thresholds, S or U, that are dependent in part on the relative sizes of the CEP ellipses; calculating a merged CEP ellipse by merging the RTT and AOA CEP ellipses; measuring the RS, RS_{mRTT}, for the merged CEP ellipse against the RTT CEP ellipse; measuring the RS, RS_{mAOA}, for the merged CEP ellipse against the AOA CEP ellipse; if the values of RS_{mRTT} and RS_{mAOA} are both less than a preset value V; displaying the merged CEP ellipse. If either or both of the values of RS_{mRTT} and RS_{mAOA} are greater than the preset value V; if RTT SF is greater than SF_{AOA} and SF_{RTT} is greater than a preset value K: selecting and displaying RTT CEP ellipse; if SF_{AOA} is greater than SF_{RTT} and SF_{AOA} is greater than K: selecting and displaying the AOA CEP ellipse; if neither SF_{RTT} nor SF_{AOA} is greater than K: not selecting nor displaying either CEP ellipse. The RS value for a first CEP ellipse against a second CEP ellipse is the ratio of the distance d between the center of the first CEP ellipse and the second ellipse, and the radius r of the first ellipse in the direction of the center of the second ellipse. The SF value is provided by the expression SF=10*e^{-RS}^{ₐᵥₑ}, where RSₐᵥₑ is the average RS value for a set of ellipses. M has a value of 3 and F has a value of 3.5. If the RTT CEP ellipse has a larger major axis than the AOA CEP ellipse; the value of the pass threshold for RS_{RTT/AOA} is less than a preset value S; and the value of the pass threshold for RS_{AOA/RTT} is less than a preset value U; if the AOA CEP ellipse has a larger major axis than the RTT CEP ellipse; the value of the pass threshold for RS_{AOA/RTT} is less than S; and the value of the pass threshold for RS_{RTT/AOA} is less than U. S has a value of 1.5 and U has a value of 1. V has a value of 0.75 and K has a value of 5

A6. A system for selecting and displaying the optimum CEP ellipse when using round trip time (RTT) and angle of arrival (AOA) for the geo-locating of a target station. The system includes at least one memory device with computer-executable instructions stored thereon; and at least one processor for executing the computer-executable instructions stored on the at least one memory device. Execution of the computer-executable instructions by the at least one processor causes the at least one processor to perform operations including transmitting, from a measuring station, a plurality of ranging packets to a target station; receiving, at the measuring station, a plurality of response packets transmitted by the target station in response to the plurality of ranging packets; determining a plurality of RTTs based on the plurality of ranging packets and the plurality of response packets, each RTT of the plurality of RTTs being the time elapsed between a transmission of a ranging packet and a reception of a corresponding response packet; determining a plurality of AOAs based on the plurality of response packets, each AOA of the plurality of AOAs corresponding to an angle that a response packet was received at the measuring station; generating RTT CEP ellipses using the best-fit location RTT parameters for the target station; generating AOA CEP ellipses using the best-fit location AOA parameters for the target station; calculating the relative separation (RS) of the latest RTT CEP ellipse against each of the 3 previous RTT CEP ellipses; the average RS, RTT RSₐᵥₑ, being a measurement of the closeness or agreement of the set of 4 RTT CEP ellipses, the lower the RS value the better; calculating the stability factor (SF) of the set of 4 RTT CEP ellipses, the higher the SF value the better; selecting and displaying the RTT CEP ellipse, if the value of RTT SF is greater than 3.5. and the value of AOA SF is less than 3.5; selecting and displaying the AOA CEP ellipse, if the value of AOA SF is greater than 3.5. and the value of RTT SF is less than 3.5; if the values of RTT SF and AOA SF are both greater than 3.5: selecting both the RTT CEP ellipse and the AOA CEP ellipse; measuring the RS between the RTT CEP ellipse and the AOA CEP ellipse, RS_{RTT/AOA}; measuring the RS between the AOA CEP ellipse and the RTT CEP ellipse, RS_{RTT/AOA}; measuring the major axis of RTT CEP ellipse, and the major axis of AOA CEP ellipse; calculating a value S as follows, where a₁ is the larger major axis, and a₂ is the smaller major axis:

$$1 < \frac{{a}_{1}}{{a}_{2}} < 1.5 \qquad S = \frac{{a}_{1}}{{a}_{2}}$$

$$\frac{{a}_{1}}{{a}_{2}} \geq 1.5 \qquad S = 1.5$$

if the major axis of RTT CEP ellipse is greater than the major axis of AOA CEP ellipse, and if RS_{RTT/AOA} less than value S and if RS_{AOA/RTT} less than 1; if major axis of RTT CEP ellipse is less than the major axis of AOA CEP ellipse, and if RS_{RTT/AOA} less than 1 and RS_{AOA/RTT} less than S; merging the RTT and AOA CEP ellipses; measuring the RS, RS_{mRTT}, between the merged CEP ellipse and the RTT CEP ellipse; measuring the RS, RS_{mAOA}, between the merged CEP ellipse and the AOA CEP ellipse; selecting and displaying the merged CEP ellipse if both RS_{mRTT} and RS_{mAOA} are lower than 0.75; selecting and displaying RTT CEP ellipse if either RS_{mRTT} or RS_{mAOA} are higher than 0.75 and RTT SF is greater than 5 and is higher than AOA SF; or selecting and displaying AOA CEP ellipse if either RS_{mRTT} or RS_{mAOA} are higher than 0.75 and AOA SF is higher than 5 and is higher than RTT SF; otherwise do not select or display a CEP ellipse.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that may be executed by a computer. Any suitable tangible computer readable medium may be utilized including hard disks, solid state drives, CD ROMs, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

While the above description contains many specifics, these should not be construed as limitations on the scope, but rather as an exemplification of several embodiments thereof. Many other variants are possible including, for examples: the number of CEP ellipses Mused to calculate ellipse agreement, the relative separation (RS) value R for acceptable agreement of the RTT or the AOA CEP ellipses, the details of the stability factor (SF) and the value F that represents acceptable agreement between CEP ellipses, the RS values, S and U, for acceptable agreement between the latest RTT and AOA CEP ellipses, the details of the merged CEP ellipse, the RS value, V, for acceptable agreement between the merged CEP ellipse and the RTT and AOA CEP ellipses, the SF value K for acceptable agreement between CEP ellipses in the case that the merged CEP ellipse is not acceptable. Accordingly, the scope should be determined not by the embodiments illustrated, but by the claims and embodiments.

It will be appreciated by persons skilled in the art that the present disclosure is not limited to what has been particularly shown and described herein above. In addition, unless mention was made above to the contrary, it should be noted that all of the accompanying drawings are not to scale. A variety of modifications and variations are possible in light of the above teachings without departing from the scope.

What is claimed is:

1. A method for geo-locating a target station, the method comprising:
transmitting, from a measuring station, a plurality of ranging packets to a target station;
receiving, at the measuring station, a plurality of response packets transmitted by the target station in response to the plurality of ranging packets;
determining a plurality of round trip times (RTTs) based on the plurality of ranging packets and the plurality of response packets;
determining a plurality of angles of arrival (AOAs) based on the plurality of response packets;
generating a plurality of RTT circular error probability (CEP) ellipses based on the plurality of RTTs;
generating a plurality of AOA CEP ellipses based on the plurality of AOAs;
calculating an RTT stability factor for a first RTT CEP ellipse, wherein the RTT stability factor indicates a level of agreement between the first RTT CEP ellipse and a preset number of immediately previous RTT CEP ellipses of the plurality of RTT CEP ellipses;
calculating an AOA stability factor for a first AOA CEP ellipse, wherein the AOA stability factor indicates a level of agreement between the first AOA CEP ellipse and a preset number of immediately previous AOA CEP ellipses of the plurality of AOA CEP ellipses;
comparing each of the RTT and AOA stability factors to a respective threshold; and
based on at least one result of the comparisons, selecting either the first RTT CEP ellipse, the first AOA CEP ellipse, both CEP ellipses, or neither CEP ellipse for display to locate the target station.

2. The method of claim 1, further comprising:
calculating a plurality of RTT relative separation parameters for the first RTT CEP ellipse, wherein the plurality of RTT relative separation parameters indicate a level of separation between the first RTT CEP ellipse and each of the preset number of immediately previous RTT CEP ellipses of the plurality of RTT CEP ellipses; and
calculating a plurality of AOA relative separation parameters for the first AOA CEP ellipse, wherein the plurality of AOA relative separation parameters indicate a level of separation between the first AOA CEP ellipse and each of the preset number of immediately previous AOA CEP ellipses of the plurality of AOA CEP ellipses.

3. The method of claim 2, wherein calculating the RTT stability factor for the first RTT CEP ellipse is based on the plurality of RTT relative separation parameters, and
calculating the AOA stability factor for the first AOA CEP ellipse is based on the plurality of AOA relative separation parameters.

4. The method of claim 3, wherein the RTT stability factor is calculated using an average of the plurality of RTT relative separation parameters and the AOA stability factor is calculated using an average of the plurality of AOA relative separation parameters.

5. The method of claim 1, wherein the first RTT and AOA CEP ellipses correspond to the RTT and AOA CEP ellipses generated from the RTT and AOA associated with a response packet most recently received by the measuring station.

6. The method of claim 1, further comprising:
in response to determining that the RTT stability factor exceeds the threshold and the AOA stability factor does not exceed the threshold, selecting the first RTT CEP ellipse for display to locate the target station;
in response to determining that the AOA stability factor exceeds the threshold and the RTT stability factor does not exceed the threshold, selecting the first AOA CEP ellipse for display to locate the target station; and
in response to determining that both the RTT and AOA stability factors exceed the threshold, selecting both the first RTT and AOA CEP ellipses for display to locate the target station.

7. The method of claim 6, further comprising:
in response to selecting both the first RTT and AOA CEP ellipses for display to locate the target station:
determining which of the first RTT and AOA CEP ellipses is the larger;
in response to determining that the first RTT CEP ellipse is the larger:
calculating a first relative separation parameter for the first RTT CEP ellipse against the first AOA CEP ellipse;
comparing the first relative separation parameter to a first threshold;
in response to determining that the first relative separation parameter is greater than the first threshold, determining not to merge the first RTT and AOA CEP ellipses;
in response to determining that the first relative separation parameter is less than or equal to the first threshold, calculating a second relative separation parameter for the first AOA CEP ellipse against the first RTT CEP ellipse;
comparing the second relative separation parameter to a second threshold;
in response to determining that the second relative separation parameter is greater than the second threshold, determining not to merge the first RTT and AOA CEP ellipses; and
in response to determining that the second relative separation parameter is less than or equal to the second threshold, merging the first RTT and AOA CEP ellipses; and
in response to determining that the first AOA CEP ellipse is the larger:
calculating a third relative separation parameter for the first AOA CEP ellipse against the first RTT CEP ellipse;
comparing the third relative separation parameter to the first threshold;
in response to determining that the third relative separation parameter is greater than the first threshold, determining not to merge the first RTT and AOA CEP ellipses;
in response to determining that the third relative separation parameter is less than or equal to the first threshold, calculating a fourth relative separation parameter for the first RTT CEP ellipse against the first AOA CEP ellipse;
comparing the fourth relative separation parameter to the second threshold;
in response to determining that the fourth relative separation parameter is greater than the second threshold, determining not to merge the first RTT and AOA CEP ellipses; and
in response to determining that the fourth relative separation parameter is less than or equal to the second threshold, merging the first RTT and AOA CEP ellipses.

8. The method of claim 7, further comprising:
in response to determining not to merge the first RTT and AOA CEP ellipses:
comparing the RTT stability factor to the AOA stability factor;
in response to determining that the RTT stability factor is greater than the AOA stability factor:
comparing the RTT stability factor to a third threshold; and
in response to determining that the RTT stability factor is greater than the third threshold, selecting the first RTT CEP ellipse for display to locate the target station; and
in response to determining that the AOA stability factor is greater than the RTT stability factor:
comparing the AOA stability factor to the third threshold; and
in response to determining that the AOA stability factor is greater than the third threshold, selecting the first AOA CEP ellipse for display to locate the target station.

9. The method of claim 7, further comprising:
in response to merging the first RTT and AOA CEP ellipses:
calculating a fifth relative separation parameter for the merged CEP ellipse against the first RTT CEP ellipse;
calculating a sixth relative separation parameter for the merged CEP ellipse against the first AOA CEP ellipse;
comparing the fifth and sixth relative separation parameters to a third threshold; and
in response to determining that at least one of the fifth and sixth relative separation parameters is less than or equal to the third threshold, selecting the merged CEP ellipse for display to locate the target station.

10. The method of claim 9, further comprising:
in response to determining that both the fifth and sixth relative separation parameters are greater than the third threshold:
comparing the RTT stability factor to the AOA stability factor;
in response to determining that the RTT stability factor is greater than the AOA stability factor:
comparing the RTT stability factor to a fourth threshold; and
in response to determining that the RTT stability factor is greater than the fourth threshold, selecting the first RTT CEP ellipse for display to locate the target station; and
in response to determining that the AOA stability factor is greater than the RTT stability factor:
comparing the AOA stability factor to the fourth threshold; and
in response to determining that the AOA stability factor is greater than the fourth threshold, selecting the first AOA CEP ellipse for display to locate the target station.

11. A system configured to geo-locate a target station, the system comprising:
at least one memory device with computer-executable instructions stored thereon; and
at least one processor for executing the computer-executable instructions stored on the at least one memory device, wherein execution of the computer-executable instructions by the at least one processor causes the at least one processor to perform operations comprising:
transmitting, from a measuring station, a plurality of ranging packets to a target station;
receiving, at the measuring station, a plurality of response packets transmitted by the target station in response to the plurality of ranging packets;
determining a plurality of round trip times (RTTs) based on the plurality of ranging packets and the plurality of response packets;
determining a plurality of angles of arrival (AOAs) based on the plurality of response packets;
generating a plurality of RTT circular error probability (CEP) ellipses based on the plurality of RTTs;
generating a plurality of AOA CEP ellipses based on the plurality of AOAs;
calculating an RTT stability factor for a first RTT CEP ellipse, wherein the RTT stability factor indicates a level of agreement between the first RTT CEP ellipse and a preset number of immediately previous RTT CEP ellipses of the plurality of RTT CEP ellipses;
calculating an AOA stability factor for a first AOA CEP ellipse, wherein the AOA stability factor indicates a level of agreement between the first AOA CEP ellipse and a preset number of immediately previous AOA CEP ellipses of the plurality of AOA CEP ellipses;
comparing each of the RTT and AOA stability factors to a respective threshold; and
based on at least one result of the comparisons, selecting either the first RTT CEP ellipse, the first AOA CEP ellipse, both CEP ellipses, or neither CEP ellipse for display to locate the target station.

12. The system of claim 11, wherein execution of the computer-executable instructions by the at least one processor causes the at least one processor to perform operations further comprising:
calculating a plurality of RTT relative separation parameters for the first RTT CEP ellipse, wherein the plurality of RTT relative separation parameters indicate a level of separation between the first RTT CEP ellipse and each of a preset number of immediately previous RTT CEP ellipses of the plurality of RTT CEP ellipses; and
calculating a plurality of AOA relative separation parameters for the first AOA CEP ellipse, wherein the plurality of AOA relative separation parameters indicate a level of separation between the first AOA CEP ellipse and each of a preset number of immediately previous AOA CEP ellipses of the plurality of AOA CEP ellipses.

13. The system of claim 12, wherein calculating the RTT stability factor for the first RTT CEP ellipse is based on the plurality of RTT relative separation parameters, and
calculating the AOA stability factor for the first AOA CEP ellipse is based on the plurality of AOA relative separation parameters.

14. The system of claim 13, wherein the RTT stability factor is calculated using an average of the plurality of RTT relative separation parameters and the AOA stability factor is calculated using an average of the plurality of AOA relative separation parameters.

15. The system of claim 11, wherein the first RTT and AOA CEP ellipses correspond to the RTT and AOA CEP ellipses generated from the RTT and AOA associated with a response packet most recently received by the measuring station.

16. The system of claim 11, wherein execution of the computer-executable instructions by the at least one processor causes the at least one processor to perform operations further comprising:
in response to determining that the RTT stability factor exceeds the threshold and the AOA stability factor does not exceed the threshold, selecting the first RTT CEP ellipse for display to locate the target station;
in response to determining that the AOA stability factor exceeds the threshold and the RTT stability factor does not exceed the threshold, selecting the first AOA CEP ellipse for display to locate the target station; and
in response to determining that both the RTT and AOA stability factors exceed the threshold, selecting both the first RTT and AOA CEP ellipses for display to locate the target station.

17. The system of claim 16, wherein execution of the computer-executable instructions by the at least one processor causes the at least one processor to perform operations further comprising:
in response to selecting both the first RTT and AOA CEP ellipses for display to locate the target station:
determining which of the first RTT and AOA CEP ellipses is the larger;
in response to determining that the first RTT CEP ellipse is the larger:
calculating a first relative separation parameter for the first RTT CEP ellipse against the first AOA CEP ellipse;
comparing the first relative separation parameter to a first threshold;
in response to determining that the first relative separation parameter is greater than the first threshold, determining not to merge the first RTT and AOA CEP ellipses;
in response to determining that the first relative separation parameter is less than or equal to the first threshold, calculating a second relative separation parameter for the first AOA CEP ellipse against the first RTT CEP ellipse;
comparing the second relative separation parameter to a second threshold;
in response to determining that the second relative separation parameter is greater than the second threshold, determining not to merge the first RTT and AOA CEP ellipses; and
in response to determining that the second relative separation parameter is less than or equal to the second threshold, merging the first RTT and AOA CEP ellipses; and
in response to determining that the first AOA CEP ellipse is the larger:
calculating a third relative separation parameter for the first AOA CEP ellipse against the first RTT CEP ellipse;
comparing the third relative separation parameter to the first threshold;
in response to determining that the third relative separation parameter is greater than the first threshold, determining not to merge the first RTT and AOA CEP ellipses;
in response to determining that the third relative separation parameter is less than or equal to the first threshold, calculating a fourth relative separation parameter for the first RTT CEP ellipse against the first AOA CEP ellipse;
comparing the fourth relative separation parameter to the second threshold;
in response to determining that the fourth relative separation parameter is greater than the second threshold, determining not to merge the first RTT and AOA CEP ellipses; and
in response to determining that the fourth relative separation parameter is less than or equal to the second threshold, merging the first RTT and AOA CEP ellipses.

18. The system of claim 17, wherein execution of the computer-executable instructions by the at least one processor causes the at least one processor to perform operations further comprising:
in response to determining not to merge the first RTT and AOA CEP ellipses:
comparing the RTT stability factor to the AOA stability factor;
in response to determining that the RTT stability factor is greater than the AOA stability factor:
comparing the RTT stability factor to a third threshold; and
in response to determining that the RTT stability factor is greater than the third threshold, selecting the first RTT CEP ellipse for display to locate the target station; and
in response to determining that the AOA stability factor is greater than the RTT stability factor:
comparing the AOA stability factor to the third threshold; and
in response to determining that the AOA stability factor is greater than the third threshold, selecting the first AOA CEP ellipse for display to locate the target station.

19. The system of claim 17, wherein execution of the computer-executable instructions by the at least one processor causes the at least one processor to perform operations further comprising:
in response to merging the first RTT and AOA CEP ellipses:
calculating a fifth relative separation parameter for the merged CEP ellipse against the first RTT CEP ellipse;
calculating a sixth relative separation parameter for the merged CEP ellipse against the first AOA CEP ellipse;
comparing the fifth and sixth relative separation parameters to a third threshold; and
in response to determining that at least one of the fifth and sixth relative separation parameters is less than or equal to the third threshold, selecting the merged CEP ellipse for display to locate the target station.

20. The system of claim 19, wherein execution of the computer-executable instructions by the at least one processor causes the at least one processor to perform operations further comprising:
in response to determining that both the fifth and sixth relative separation parameters are greater than the third threshold:
comparing the RTT stability factor to the AOA stability factor;
in response to determining that the RTT stability factor is greater than the AOA stability factor:
comparing the RTT stability factor to a fourth threshold; and
in response to determining that the RTT stability factor is greater than the fourth threshold, selecting the first RTT CEP ellipse for display to locate the target station; and
in response to determining that the AOA stability factor is greater than the RTT stability factor:
comparing the AOA stability factor to the fourth threshold; and
in response to determining that the AOA stability factor is greater than the fourth threshold, selecting the first AOA CEP ellipse for display to locate the target station.
